(19) United States
(12) Patent Application Publication
(10) Pub. No.: US 2006/0165903 A1
(43) Pub. Date: Jul. 27, 2006

(54) Method for the decoration of porous ceramic materials and in particular polished porcelain stoneware

(76) Inventor: Raffaello Mazzanti, Rastignano-Bologna (IT)

Correspondence Address: HEDMAN & COSTIGAN P.C., 1185 AVENUE OF THE AMERICAS, NEW YORK, NY, 10036, US

(21) Appl. No.: 10/529,442

(22) PCT Filed: Oct. 1, 2003
(86) PCT No.: PCT/EP03/10927

§ 371 Date: Mar. 28, 2005

(30) Foreign Application Priority Data
Oct. 1, 2002 (IT) MI2002-A002072

(51) Int. Cl. B05D 3/02; B05D 5/00; B05D 1/36; B05D 1/30; B05D 1/02; C08F 2/46

(52) U.S. Cl. 427/372.2; 427/402; 427/429; 427/421.1; 427/428.01; 427/258; 427/420; 427/487

(57) ABSTRACT

The present invention relates to a method for the decoration of porous ceramic materials and in particular polished porcelain stoneware comprising the application of a pigment or dye suitably carried on a ceramic substrate so as to allow said pigment or dye to penetrate the surface pores of the ceramic substrate, an optional drying of the colored substrate and the subsequent application of a hardenable composition in order to fix the decoration applied to the ceramic substrate. Another option for the decoration consists in the application of a pigmented hardenable composition. The hardenable composition advantageously consists of a photocurable composition.

The present invention relates to a method for the decoration of porous ceramic materials and in particular polished porcelain stoneware.

It should be noted that the term “to polish” as used in the description of the invention, indicates a surface treatment that includes polishing, smoothing, lapping, brushing and the like.

In particular, the present invention relates to a method for applying a decoration with a high aesthetic content of ceramic materials having surface porosity.

Ceramic materials for lining or flooring are currently decorated with numerous techniques to obtain materials of a highly aesthetic value.

The decoration is normally effected on dried or toasted supports, which usually comprise a final baking.

In particular, it is known that in the case of polished porcelain stoneware, a material which. is widely used for its mechanical and aesthetic characteristics, various decorative types are used, such as those indicated in the monograph “Gres Fine Porcellanato” (Porcelain Stoneware) published by SACMI.

It is known that a traditional fired decoration is capable of producing materials with good aesthetic properties, thus satisfying market demands.

It has been observed, however, that fired decoration is not a flexible technology, which does not allow the production of small lots and only exploits the use of inorganic pigments which considerably limit the range of colors which can be obtained.

At present, if a personalized decoration is desired, resort must be made to a third firing which consists in decorating an already baked material.

It has been found that although this technique allows the production of small lots also with wider chromatic ranges, the decorated products obtained are less resistant with respect to decorations effected on line. Furthermore, third firing decoration is limited by the fact that it can almost exclusively be affected on lining materials, whereas flooring materials are decorated on line before baking.

Current market demands are becoming increasingly more oriented towards personalized materials with a high aesthetic content. In particular, in the case of commercial building, the possibility of obtaining particular effects exceeds the necessity of long-lasting materials.

These demands consequently require a new technology, which is suitable for the decoration of lining or flooring ceramic materials.

One of the main objectives of the present invention therefore consists in supplying a method for the decoration of porous ceramic materials and in particular polished porcelain stoneware that is simple to effect and has low operating costs.

With the method according to the invention, it is possible to decorate flooring and lining materials of varying kinds and origins, such as ceramics, glazed ceramics, porcelain stoneware, glazed porcelain stoneware, cement and resin-based composites, burned-clay (terracotta) and natural stones such as granite and marble. Materials listed above may be natural or with a surface treatment such as polishing, smoothing, lapping, brushing and the like.

A further objective of the present invention consists in supplying a method for the decoration of ceramic materials, which allows the production of small lots with a wide range of chromatic variations.

Another objective of the present invention consists in producing a decorated ceramic material which cannot be easily attacked by external agents and which allows an effective and rapid removal of dirt and stains from its surface.

The present invention derives from the discovery that the surface pores of ceramic materials and polished porcelain stoneware in particular, are suitable for fixing dyes or colored pigments, when appropriately applied.

Accordingly the present invention provides a method for the coloration or decoration of porous ceramic substrates as claimed in the appended claims.

In accordance with a first aspect of the present invention, a method is provided for the decoration of a porous ceramic substrate, in particular polished porcelain stoneware, comprising:
1) The application of a dye or pigment on at least a portion of a ceramic substrate having surface microporosities, so as to allow said dye or pigment to penetrate the pores of said ceramic substrate;
2) The application of a hardenable composition on said portion of colored ceramic substrate, in order to allow said composition to penetrate the colored or pigmented pores of said ceramic substrate,
3) The polymerization or drying of said hardenable composition to fix the dye or pigment applied to the treated substrate.

The application phase 2) of the method of the invention is conveniently effected when the ceramic substrate treated according to phase 1) is dry. For example, it is possible to dry the ceramic substrate after applying the dye or pigment and/or subject it to fixing.

In accordance with a second aspect of the present invention, a method is provided for the decoration of a porous ceramic substrate, in particular polished porcelain stoneware, comprising:
1) The application of a colored hardenable formulation on at least a portion of a ceramic substrate having surface microporosities, so as to allow said formulation to penetrate the pores of said ceramic substrate. The formulation comprises a polymer/pre-polymer that can contain any type of dye/pigment suitable for providing the desired color. Such formulation can be easily recognized as ink.
2) The polymerization or drying of said hardenable composition.

The pigments or dyes used within the scope of the invention are preferably of the organic type. In particular the use of pigments is preferred as their stability to light is much higher.

According to an embodiment of the invention, the pigment or dye is associated with a suitable carrier which, when applied to the surface of the ceramic substrate ensures its penetration inside the surface porosity thereof.

The application of one or more pigments/dyes according to the present invention allows a wide range of colors to be obtained with consequent exceptional aesthetic properties of the ceramic end product.

The pigment can be conveniently used in preparation form, such as for example, pastes, dispersions, etc. The dispersions can typically contain a dispersing agent called stabilizer that can be, for example, a polyester, a polyurethane, typically incorporated in a quantity of 2.5% to 100% by weight of the pigment.

The formulation of the dye is suitably selected to allow a rapid penetration in the pores of the ceramic material to be treated and subsequent easy evaporation of the carrier, thus leaving the pigment/dye alone in the pore. The carrier used can typically be in the form of an aqueous solution, solvent or consisting of an organic resin. The pigment/dye can typically be in the form of a solution, dispersion or emulsified in the carrier. It can also be present in colloidal form or in the form of a complex.

According to an embodiment of the invention, the coloring composition can contain additives, which facilitate the dispersion of the pigment, the stability of the formulations, wettability of the substrate.

The application of the formulation containing the pigment/dye can be typically effected by resorting to techniques used in graphic arts, such as for example off-set printing, flexography, screen-printing, gravure printing, digital printing, used in coating applications such as for example roll-, film-, spray-, pallet, disk-techniques by means of a brush or vacuum technology or also hand decorations with traditional techniques (brush, pad, aerograph).

Among the techniques mentioned, the digital technique in particular allows personalized images to be obtained together with high production flexibility. With this technology, various types of images can therefore be obtained, such as reproductions of images or the reproduction of natural stones.

It has been found that the high flexibility in formulating with organic pigments/dyes enables a wide range of colors with numerous shades, to be obtained. The different shades give the material effects of depth and consequently effects, which imitate natural stones and complex images, can be reproduced.

Within the scope of the invention, it is possible to use a wide variety of dyes and pigments combined with each other or alone. The pigments can have various colors, for example process colors like cyan, magenta, yellow, black or other colors like white, green, violet, brown, scarlet and mixtures of these.

Among the organic pigments which can be used within the scope of the invention, the following can be mentioned, for example, Cinquasia, Cromophtal, Irgazin, Irgalite (Ciba Specialty Chemicals), among the aqueous dispersions of pigments Microsol, Unisperse (Ciba Specialty Chemicals), among pigments in preparations, concentrates, dispersions, Irgalite, Microlith, Filofin, Micranyl (Ciba Specialty Chemicals).

Among inorganic pigments, the following are included: Hornatherm, Hornachrome, Horna, Irgacolor (Ciba Specialty Chemicals), titanium oxide.

Dyes that can be used are, for example, special dyes Orasol, Oracet, Filamid, Filester (Ciba Specialty Chemicals). Natural dyes such as coffee, anthocyanins, etc. can also be used.

A selection of pigments which can be used in the context of the invention is listed, for example, in the publication “Industrial Organic Pigments, Production, Properties, Application”, second edition, W. Herbst, K. Hunger; VCH 1997.

In addition to the above pigments, pigments with a particular chromatic effect can be advantageously used, such as metallic, metallescent, micalized, pearlescent pigments, for example pigments supplied by Merck (IRIO-DIN), Eckart etc.

According to an embodiment of the invention, said pigment is applied in the form of dispersion in a suitable liquid such as water or an organic solvent.

With the method according to the invention, it is possible to decorate materials or substrates for various types of flooring and lining and of various origins, such as ceramics, concrete and resinous agglomerates, terracotta and natural stones such as granite and marble.

Particularly favorable results are obtained by treating porous ceramic substrates such as polished porcelain stoneware.

According to a preferred embodiment of the invention, said hardenable composition is a photocurable resin or composition.

The term photocuring reaction refers to the curing and hardening of the reactive component, obtained as a result of exposure to radiation preferably having a wave-length ranging from 100 to 780 nm, more preferably from 250 to 460 nm. In particular, the exposure to UV rays is particularly suitable for reaching, in a short period of time and with low costs, a high curing degree of the reactive components contained in the photocurable composition.

The reactive components can be subdivided into two main categories: the group of radicalic systems and of cationic systems.

The compounds belonging to the radicalic group contain an ethilenically unsaturated group. The compounds having an ethilenically unsaturated group may be an oligomer or a monomer. The oligomers is a compound having two or more ethilenically unsaturated group within one molecule and governing various properties of cured compound obtained by radical polymerization, such as abrasion resistance, durability, weatherability, adhesion, etc.

The monomer is further classified into a monofunctional monomer having one unsaturated group and a polyfunctional monomer having two ore more unsaturated groups.

It should be noted that the term (meth)acrylate as used in the description of the invention, indicates both acrylates and methacrylates.

Specific examples of the oligomers having an ethylenically unsaturated group for use in the present invention include an unsaturated polyesters resin (UPES) (for example Roskydal 300, 502, 700, BAYER; Alpolith 303 Hoechst; Distitron VE100, 417, 191, LONZA) an epoxy (meth)acrylate resin (for example Ebecryl 600, 3200, 3500, UCB Chemicals; CRAYNOR CN104, CN116, CN154, CN132, CN133, ATOFINA), a urethane (meth)acrylate resin (for example, Ebecryl 230, 270, 1290, 5129, UCB Chemicals; CRAYNOR CN965, CN966, CN963, CN975, ATOFINA); a polyester (meth)acrylate resin (for example Ebecryl 80, 81, 83, 84, UCB Chemicals), an amine modified polyester (meth)acrylate resin, a polyether (meth)acrylate resin (for example CRAYNOR CN501, CN502, CN551, CN552, ATOFINA), an acrylic (meth)acrylate (for example Ebecryl 745, 767, UCB Chemicals), a polybutadiene (meth)acrylate resin (for example CRAYNOR 301, 303, ATOFINA), a silicone (meth)acrylate resin, etc.

This photocurable composition advantageously includes reactive diluent (monomer) which can act both as a diluent for the viscosity control of the composition, and as a reagent which intervenes in the photocuring process, thereby improving workability, penetration into the porosities, etc.

The monofunctional monomers, which can be used within the scope of the invention include:
a) Monofunctional monomers, preferably selected from:
   vinyls for example styrene;
   (meth)acrylates for example Ebecryl 110, 112, 114, UCB Chemicals; SR335, SR395, SR489, SR256, SR504, SR285, SR339, SR506, ATOFINA; IBOA, ODA-N or
b) Polyfunctional monomers, selected from bifunctional, (for example Ebecryl 150, UCB Chemicals; SR238, SR268, SR272, SR306, SR508, SR259, SR344, SR610, SR9003, SR349, SR602, ATOFINA; DPGDA, HDDA, TPGDA) and others (for example Ebecryl 40, 140, 160, UCB Chemicals, SR295, SR351, SR444, SR355, SR399, SR415, SR454, SR492, SR9020, SR9021, ATOFINA; DPHPA, OTA, TMPTA).

The prepolymers which can be used, belonging to the group of cationic systems also comprise epoxy monomers and oligomers (for example CYRACURE UVR6105, UVR6110, UVR6128, UVR6000, UVR6100, UVR6216, UNION CARBIDE, limonene dioxide, linseed oil epoxide-LOE); polyols (for example TONE series 200, 300, UNION CARBIDE); epoxy silicones (for example UV 9600 series, GE Bayer Silicones); vinyl-ethers (for example RAPICURE, ISP Chemicals); glycols (for example PEG with varying molecular weights). A wide variety of commercial epoxy resins are available and listed in “Handbook of Epoxy Resins” by Lee and Neville, McGraw Hill Book Company, New York (1967).

The photocurable composition of the present invention may be a hybrid mixture containing both radicalic and cationic systems.

The formulations containing the above compounds can also be classified on the basis of the following classification:
With solvent
   100% photo-curable (preferred)
   Aqueous based (dispersion or emulsion).

The photocurable composition of the present invention is in the form of a solvent free material but may also be used by diluting it with a solvent as conventionally employed. In this case, the solvent used may be a solvent commonly used in conventional coating materials and examples thereof include aromatic hydrocarbons such as toluene and xylene; alcohols such as ethanol, 2-propanol and 1-butanol; ketones such as methyl ethyl ketone and methyl isobutyl ketone; ethers such as diethylene glycol dimethyl ether and triethylene glycol dimethyl ether; esters such as ethyl acetate and butyl acetate; and monoethers of ethylene glycol such as methyl cellosolve and ethyl cellosolve. These solvents may be used individually or in combination of two or more thereof. The organic solvent is used so as to reduce the viscosity of the composition and improve the workability. Moreover the photocurable composition of the present invention may be in the form of an aqueous or aqueous/solvent dispersion or emulsion.

In the formulation of the photocurable compositions of the invention there are also advantageously one or more photoinitiators, co-initiators, synergic agents.

Photoinitiators for free radical polymerization which can be used, for example, are alpha-hydroxyketones (for example IRGACURE 184, 2959, DAROCUR 1173, Ciba Specialty Chemicals; ESACURE KIP 150, LAMBERTI S.P.A.), alpha-aminoketones (for example IRGACURE 907, 369, Ciba Specialty Chemicals; ESACURE 1001 LAMBERTI SPA), acyl-phosphinoxides (for example IRGACURE 819, 1800, 1850, 1700, Ciba Speciality Chemicals); LUCIRIN TPO, TPO-L, BASF), thioxanthones (for example SPEEDCURE ITX, DETX, CTX, CPTX, LAMBSON), benzophenones (for example ESACURE TZT, TZM, LAMBERTI SPA; benzophenone, substituted benzophenones), oxime-esters, anthracenes, benzyl-dimethyl-ketals (for example IRGACURE 651, Ciba Specialty Chemicals; ESACURE KB1, LAMBERTI), phenyl-glyoxylates (for example Darocur MBF, Ciba Specialty Chemicals) synergic amines (for example SPEEDCURE EDB, EHA, DMB, PDA, LAMBSON), tertiary amines.

Photoinitiators for cationic polymerization include all substances, which liberate Lewis or Bröensted acid upon exposure to actinic radiation. Cationic photoinitiating systems which are particularly useful in the composition of the present invention are arylsulfonium salts, especially the triarylsolfonium salts for example CYRACURE UVI 6976, 6992, UNION CARBIDE; Sp-55, 150, 170, Asahi Denka) and aryl-iodonium salts (for example CGI 552, Ciba Specialty Chemicals; CD1012, SARTOMER) and metallocenes (for example IRGACURE 261, Ciba Specialty Chemicals).

The photocurable composition of the present invention may contain a thermal polymerization inhibitor for the purpose of preventing polymerization during the storage. Specific examples of the thermal polymerization inhibitor, which might be added to the photocurable composition of the present invention, include p-methoxyphenol, hydroquinone, alkyl-substituted hydroquinone, catechol, tert-butyl cathecol and phenotiazine.

The photocurable composition of the present invention may of course contain organic peroxide such as thermo polymerization initiator for the purpose of accelerating curing and allowing curing were light can not penetrate into the formulation. Specific examples of the organic peroxide include benzoyl peroxide, dicumyl peroxide, di-tert-butyl peroxide, tert-butyl peroxybenzoate, tert-butyl peroxy-2-ethylexanoate, tert-butyl peroxylaurate, tert-butyl hydroperoxide, dicumil hydroperoxide, 3,3,5-trymethylhexanoyl peroxide, diisopropyl peroxydicarbonate. In order to accelerate the curing, a cobalt salt such as cobalt naphtenate and cobalt octylate, or an amin compound such as dimethylaniline, might be used in combination with above described organic peroxide.

In a second embodiment of the invention the hardenable composition might be waterborne and solventbased Alkyd resin (e.g. Synolac, Gelkyd, Unithane, Synaqua—CRAY VALLEY; Uralac, Urathix, Uradil—DSM; Alkydal—BAYER; Laropal—BASF; Vialkyd, Daotan, Resydrols—VIANOVA), waterborne and solventbased Acrylics; waterborne, solventbased or 2-pack Epoxies, waterborne and solventbased Saturated polyesters, waterborne, solventbased or 2-pack Polyurethanes, Phenolic resins or phenolplasts.

Such hardenable compositions might be self-crosslinkable or thermosetting.

The hardenable composition of the present invention may contain filler/s for the purpose of increasing abrasion resistance and adhesion to the porosities. Specific examples of fillers include inorganic fillers such as calcium carbonate, aluminum hydroxide, calcium sulfate, barium sulfate, talc, alumina, silicon dioxide, glass powder, ceramic powder etc. and organic fillers: organic polymers such as Teflon, polystyrene resin, polyurethane resin, polyvinylacetal resin, polyvinylbutyral resin, saturated polyester resins, chlorinated polyolefin; rubber components such as butadiene rubber, styrene-butadiene rubber, nitrile rubber and acryl rubber; various type of thermo-plastic elastomers such as polystyrene type, polyolefin type, polydiolefin type, polyurethane type, and polyester type; and homopolymers and copolymers of (meth)acrylic acid alkyl ester such as polyethyl(meth)acrylate and polybutyl (meth) acrylate.

The above listed compounds may be used in a form of nano-particles.

The hardenable composition of the present invention may further contain general additives for coating materials so as to improve workability and physical properties of the formulation before and after curing. Examples of the additives include:

Adhesion promoters (for example CN704, CN736, CN9050, CN9051, ATOFINA), wetting agents, surface-active agents (for example Silwet, Silquest, CoatOSil, WITCO; BYK 3500, 3510, 3530, 3570, 310, 306, 307, 333, 341, 344, P104, 104S, 105, 220S, Lactimon, BYK Chemie), bactericides (for example IRGASAN, Ciba Speciality Chemicals), fluorinated monomers (for example 1H,1H,2H,2H-hepta-fluorodecyl-acrylate, 2-(perfluorobutyl)-ethyl acrylate, 2-(perfluorodecyl) -ethylacrylate DAIKIN; ZONYL Dupont), abrasion resistance agents (for example BYK 306, 307, 310, 333, 341, BYK Chemie), dispersing agents, viscosity modifiers

Furthermore, the hardenable composition of the present invention may contain an antioxidant, a photostabilizer or an ultraviolet absorbent for the purpose of preventing photodeterioration after curing the composition into the porosities. Examples of the antioxidants include hindered phenol type antioxidants such as 2,4,6-tri-tert-butylphenol, 2,6-di-tert-butyl-p-cresol, N,N′-hexamethylene bis(3,5-di-tert-butyl-4-hydroxy-hydrocinammide, octadecyl-3(3,5-di-tert-butyl-4-hydroxyphenyl)propionate, 3,5-di-tert-butyl-4-hydroxy-benzylphosphonate-diethyl ester, isooctyl-3-(3,5-di-tert-butyl-4-hydroxyphenyl)propionate, and tris (3,5-di-tert-butyl,4,hydroxybenzyl)isocyanurate; phosphite-type anti-oxidants such as triphenylphosphite, tris(2,4-di-tert-butylphenyl)phosphite, tris(nonylphenyl)phosphite, di-pheninylisodecylphosphite, phenyldiisodecylphosphite, cyclic neopentane-tetrayl bis(octadecylphosphite) and 2,2-methylene bis (4,6-di-tert-butylphenol)octylphosphite; and thioether-type antioxidants such as dilauryl 3,3′-thiodipropionate, dimyristyl 3,3-thiodipropionate and pentaerythryl tetrakis(3-laurylthioproponate).

Examples of the photostabilizers include hindered amine-type photostabilizers such as bis(2,2,6,6-tetramethyl-4-piperidyl)sebacate, bis(1,2,2,6,6-pentamethyl-4-piperidyl)sebacate, bis(1,2,2,6,6-pentamethyl-4-piperidyl)-2-(3,5-di-tert-butyl-4-hydroxybenzyl)-2-n-butylmalonate and 4-benzoyloxy-2,2,6,6-tetramethylpiperidine.

Examples of the ultraviolet absorber include benzotriazole-type compounds such as 2-(3,5-di-tert-butyl-2-hydroxyphenyl)benzotriazole, 2-(3-tert-butyl-5-methyl-2-hydroxyphenyl)benzotriazole and 2-(3,5-di-tert-amyl-2-hydroxyphenyl)benzotriazole; benzoate-type compounds such as 2,4-di-tert-butyl-phenyl-3,5-di-tert-butyl4-hydroxy-benzoate; salicylate-type compounds such as p-tert-buthylphenylsalicylate and p-octylphenylsalicylate; benzophenone-type compounds such as ethyl-2-cyano-3,3′-diphenil acrilate and 2 ethylhexyl-2-cyano-3,3′-diphenyl acrilate, and metal complexes such as nickel bis(octylphenyl)sulfide and nickel dibutyldithiocarbamate.

The hardenable composition can be applied to the material to be decorated by means of techniques used in graphic arts, such as for example offset printing, flexography, screen-printing, gravure printing, digital printing, used in coating applications such as for example roll-, film-, spray-, pallet, disk-techniques by means of a brush or vacuum technology or also hand decorations with traditional techniques (brush, pad, aerograph).

In accordance with an embodiment of the invention, a quantity of the hardenable composition ranging from 0.1 to 25 g/m² is applied to the material to be decorated, as uniformly as possible along the whole surface area.

In particular, in the case of the treatment of polished porcelain stoneware and material with reduced opened porosity, it is preferable to apply a quantity of hardenable composition ranging from 0.5 to 5 g/m² whereas when porous ceramic materials, such as burned-clay, natural stones and cement and resin-based composites, are treated, it is preferable to apply a quantity of photocurable composition ranging from 2 to 10 g/m².

An embodiment of the method of the invention envisages the application of the hardenable composition on the surface of the colored ceramic substrate and subsequent drying or polymerization of such hardenable resin. The hardened surface polymeric layer is then removed, for example by means of disking (with abrasives) and the treated material is then transferred to a subsequent processing phase.

According to a preferred embodiment of the method of the invention, the hardenable composition is initially applied to the decorated/colored ceramic substrate, ensuring its penetration in the surface pores and the excess surface amount applied is then removed for example using a scraper, the non-cured product being transferred for recycling. The hardenable composition is the dried/polymerized. After the polymer of said composition has hardened, the material treated is passed to other possible processing or finishing phases.

According to another embodiment of the invention, the hardenable composition is applied to the ceramic substrate and dried/polymerized. Following the curing process, a colored or decorated polymeric surface layer is formed, which is left unaltered, or optionally, removed at the moment of the laying of the material.

According to an embodiment of the invention, before the drying, it may be convenient to treat the substrate with a solution of a weak, non-aggressive acid, (for example sulfamic acid, diluted hydrochloric acid, etc.) which allows the removal of the polishing residues, for example magnesium carbonate without damaging the substrate itself. This acid treatment process allows better decorative results. The method of the invention is advantageously carried out in line with treatment operations of building materials suitable for flooring or lining, or, alternatively, in the finishing phase for third parties.

The use of the photocurable technology within the scope of the method of the invention allows an effective curing of the formulation applied.

Furthermore, the use of the photocurable technology makes the method of the invention extremely versatile enabling it to be included in the common processing procedures of ceramic materials. In the specific case of polished porcelain stoneware, it is possible to carry out the method of the invention after the smoothing phase, following possible drying treatment to eliminate the presence of residual water. The drying before the protective treatment of the material can be effected by forced hot air ventilation, with the use of an IR lamp or alternative technologies.

According to an embodiment, the method of the invention can also be used out of line, after the laying of the material itself, resorting to the use of appropriate equipment.

The use of the photocurable technology enables high drying rates, allowing a flow ranging from 1 to 200 m/min of material to be treated, enabling direct on-line production use, as the other operations such as polishing, are effected at lower rates, generally ranging from 4 to 15 m/min.

The embodiment of the method of the invention comprises the use of light sources advantageously having an emission of 100 to 780 nm, preferably with a wave-length ranging from 250 to 460 nm.

The light source, which emits ray absorbed by photoinitiator, can be used to cure the photocurable composition of the present invention. Examples of the light source include a medium pressure mercury lamp, a high pressure mercury lamp, a metal halide lamp, a excimer lamp, a short arc metal lamp, a short arc metal halide lamp, a xenon lamp, a fluorescent lamp and sunlight. When these light sources are used, the expose energy needed for curing the photocurable coating composition of the present invention is in a range from 0.05 to 1.5 J/cm², preferably in a range from 0.1 to 1.0 J/cm².

The light sources can differ depending on the type of ignition, arc or microwaves and emission spectrum, Hg or Hg doped with Ga, Ta, Pb, Fe, and other doping agents.

As an example, fluorescent lamps which can be used are fluorescent lamps TLO3 or TLO5 of Philips, medium pressure lamps or complete systems produced by FUSION, IST, HERAEUS, PHILIPS, AMBA, THEIMER, SYLVANIA, high pressure lamps of FUSION, IST, HERAEUS, PHILIPS, AMBA, THEIMER, SYLVANIA, excimer lamps, so-called cold lamps or monochromatic sources such as lasers.

The following examples are provided for the sole purpose of illustrating the present invention and should in no way be considered as limiting its protection scope, as defined by the enclosed claims.

Following examples are referring to application of the pigmented solution/dispersion followed by application of the hardenable resin.

### EXAMPLE 1

| Pigmented (cyan) formulation: | |
|---|---|
| Microlith Blue 4G-WA | 25 g |
| Water | 65 g |
| Isobutanol | 8 g |
| Dmea | 2 g |
| Let down | |
| Pigmented formulation: | 40 g |
| Water | 65 g |
| Mowiol 23-88 | 1 g |

### EXAMPLE 2

| Pigmented (cyan) formulation | |
|---|---|
| Microlith Blue 4G-WA | 16 g |
| 1-methoxy-2-propanol | 40 g |
| Isopropanol | 20 g |
| Ethanol | 18 g |
| Butylacetate | 4 g |
| Nitrocellulose A400 | 2 g |

### EXAMPLE 3

| Dye formulation | |
|---|---|
| Orasol Red BL | 2 g |
| 1-methoxy-2-propanol | 38 g |
| Isopropanol | 20 g |
| Ethanol | 10 g |
| Butylacetate | 28 g |
| Nitrocellulose A400 | 2 g |

### EXAMPLE 4

| Dye formulation | |
|---|---|
| Orasol Red BL | 2 g |
| 1-methoxy-2-propanol | 38 g |
| Isopropanol | 20 g |
| Ethanol | 10 g |
| Butylacetate | 28 g |
| Nitrocellulose A400 | 2 g |

### EXAMPLE 5

| Pigmented (red) formulation | |
|---|---|
| Irgasperse Red G-U | 3 g |
| 1-methoxy-2-propanol | 40 g |
| Isopropanol | 17 g |
| Ethanol | 40 g |

### EXAMPLE 6

| Photocurable formulation | | |
|---|---|---|
| CN 501 | 60 | g |
| TPGDA | 20 | g |
| CN 104D80 | 12 | g |
| IRGACURE 184 | 2 | g |
| IRGACURE 819 | 0.5 | g |
| TINUVIN 292 | 1 | g |
| TINUVIN 400 | 1.5 | g |
| Additives | 3 | g |

### EXAMPLE 7

### Process

The formulations indicated in Examples 1-5 were applied by means of a pad on a substrate of white polished porcelain stoneware, washed with an acid solution (10% sulfamic acid in water) to eliminate any possible smoothing residues in the pores of the material and the surface was then cleaned with a cloth soaked in alcohol.

The pigmented/dyed formulation was completely absorbed by the material.

After drying the surface with hot air, the photocuring formulation of Example 6 was applied by dripping it onto the substrate and applied by means of a rubber doctor blade in order to push the product into the open porosities of the material. The excess surface layer was subsequently removed with soft paper.

Following examples are referring to application of the pigmented hardenable formulation.

### EXAMPLE

| Pigmented (cyan) waterborne UV curable formulation: | | |
|---|---|---|
| CN 132 | 50 | g |
| SR 435 | 20 | g |
| Water | 13 | g |
| Microlith Blue 4G-WA | 10 | g |
| IRGACURE 184 | 2 | g |
| IRGACURE 819 | 0.5 | g |
| TINUVIN 292 | 1 | g |
| TINUVIN 400 | 1.5 | g |
| Additives | 3 | g |

### EXAMPLE 9

| Pigmented (cyan) UV curable formulation: | | |
|---|---|---|
| CN 5O1 | 40 | g |
| CN 965 | 30 | g |
| TPGDA | 12 | g |
| Microlith Blue 4G-A | 10 | g |
| IRGACURE 184 | 2 | g |
| IRGACURE 819 | 0.5 | g |
| TINUVIN 292 | 1 | g |
| TINUVIN 400 | 1.5 | g |
| Additives | 3 | g |

### EXAMPLE 10

| Pigmented (cyan) waterborne acrylics: | | |
|---|---|---|
| Water | 34.11 | g |
| Microlith Blue 4G-WA | 10 | g |
| Wetting agent | 0.03 | g |
| Silicone emulsion defoamer | 0.05 | g |
| Coalescent | 0.03 | g |
| Ethylene glycol | 0.03 | g |
| Plasticiser | 3.50 | g |
| Tributoxy ethyl phosphate | 0.03 | g |
| Biocide | 0.01 | g |
| Rhoplex WL-91 (Rohm and Haas) | 42.27 | g |

### EXAMPLE 11

| Pigmented (cyan) waterborne acrylics: | | |
|---|---|---|
| Glascol C44 | 89.9 | g |
| Microlith Blue 4G-WA | 10 | g |
| Wetting agent | 0.03 | g |
| Silicone emulsion defoamer | 0.05 | g |
| Coalescent | 0.02 | g |

### EXAMPLE 12

| Pigmented (cyan) alkyds: | | |
|---|---|---|
| Crodakyd 466/60 | 70 | g |
| Microlith Blue 4G-A | 10 | g |
| Cymel 303 | 7 | g |
| Nacure 2500 | 0.6 | g |
| Fluorad FC 430 | 0.6 | g |

| | |
|---|---|
| Butyl Acetate | 11, 8 6 |

### EXAMPLE 13

| Pigmented (cyan) solvent free polyurethane: | | |
|---|---|---|
| Part A | | |
| Branched polyether/polyester resin | 40 | g |
| Microlith Blue 4G-A | 10 | g |
| Molecular sieve zeolite paste | 0.5 | g |
| Defoamer | 0.5 | g |
| Barytes | 19 | g |
| Part B | | |
| MDI polyisocyanate | 15 | g |

### EXAMPLE 14

### Process

The hardenable formulations (Examples 8-13) were applied by dripping it onto a substrate of white polished porcelain stoneware, washed with an acid solution (10% sulfamic acid in water) to eliminate any possible smoothing residues in the pores of the material and the surface was then cleaned with a cloth soaked in alcohol, and applied by means of a rubber doctor blade in order to push the product into the open porosities of the material. The excess surface layer was subsequently removed with soft paper.

The photocurable formulations were cured using a laboratory belt UV unit with the following characteristics:
Medium pressure lamp (Hg);
Power applied: 120 W/cm;
Belt speed: 10 m/min.

The thermal hardenable formulations were cured using an IR lamp.

The material decorated in this way has an excellent chromatic yield with stain-proof characteristics.

Exposure to Sunlight

After 6 months of exposure to sunlight, the samples proved to have maintained their original color.

Tread Test

The samples placed in a highly tread environment, have the same coloring after 6 months.

After application, the substrate is uniformly colored and has excellent stain-proof characteristics.

In general photocurable formulations have shown best results.

1-23. (canceled)

24. A method for the decoration of a porous ceramic substrate, comprising:
1) applying a colorant composition comprising a colorant material and a carrier on at least a portion of a ceramic substrate having surface microporosities, such that said colorant composition penetrates the pores of said ceramic substrate;
2) applying a hardenable resin on the treated portion of the ceramic substrate,
3) polymerizing or drying said hardenable resin to fix the colorant material to the ceramic substrate.

25. The method according to claim 24, wherein said colorant material is a pigment or dye suitable for application on ceramic substrates.

26. The method according to claim 24 comprising the application of a pigment dispersed in a volatile dispersing agent.

27. The method according to claim 24, wherein said pigment comprises a pigment selected from natural, organic, effect pigments such as metallic, metallescent, micalized pigments and their mixtures.

28. The method according to claim 24, wherein said application phase is carried out by means of a manual technique selected from pads, brushes, aerographs, or a non-manual technique selected from flexography, screen-printing, gravure printing, digital printing, offset printing, roller coating, curtain coating, spray, vacuum.

29. The method according to claim 24, wherein it comprises an intermediate drying phase of the dye or pigment applied.

30. The method according to claim 24, wherein it comprises a final polishing phase of the decorated ceramic substrate.

31. The method according to claim 24, wherein said hardenable composition is a photo-curable resin or a composition curable with ultraviolet rays (UV).

32. The method according to claim 24, wherein said irradiation is effected by exposure to an electromagnetic radiation with a wavelength ranging from 100 to 780 nm.

33. The method according to claim 32, wherein said irradiation is effected by exposure to UV-VIS rays.

34. The method according to claim 31, comprising the application of a quantity ranging from 0.1 to 25 g/m² of said photo-curing composition on the substrate to be treated.

35. The method according to claim 31, wherein said photo-curing composition comprises a prepolymer selected from radicalic systems, cationic systems and their mixtures.

36. The method according to claim 35, wherein said prepolymer is a radicalic system selected from the group consisting of unsaturated polyesters, epoxy acrylates, urethane acrylates, aromatic urethanes, aliphatic urethanes, polyester acrylates, polyether acrylates, acrylic acrylates and their mixtures.

37. The method according to claim 35, wherein said prepolymer is a cationic system selected from the group consisting of epoxy monomers, epoxy oligomers, polyols, vinyl-ethers, glycols and their mixtures.

38. The method according to claim 31, wherein said curing composition further comprises one or more reactive diluents and/or additives selected from the group consisting of adhesion promoters, wetting agents, surface-active agents, light stabilizers, bactericides, fluorinated monomers, abrasion resistance additives, dispersing agents, viscosity modifiers, fillers, pigments, polymerization inhibitors, stabilizers.

39. The method according to claim 31, wherein said curing composition comprises at least one photoinitiator.

40. The method according to claim 39, wherein said photo-initiator is selected from the group consisting of alpha-hydroxyketones, alpha-aminoketones, acylphosphinoxides, thioxantones, benzophenones, oxymesters, anthracenes, benzyl-dimethyl-ketals, benzoin ethers, amines and their mixtures.

41. The method according to claim 24 wherein the application and curing phases by means of irradiation are repeated two or three times on the same ceramic substrate.

42. The method according to claim 24 comprising a preliminary treatment phase of said ceramic substrate with a solution at acid pH.

43. The method according to claim 24, wherein the hardenable composition is selected from the group consisting of waterborne and solvent based Alkyd resin (e.g. Synolac, Gelkyd, Unithane, Synaqua—CRAY VALLEY; Uralac, Urathix, Uradil—DSM; Alkydal—BAYER; Laropal—BASF; Vialkyd, Daotan, Resydrols—VIANOVA), waterborne and solventbased Acrylics; waterborne, solventbased or 2-pack Epoxies, waterborne and solventbased Saturated polyesters, waterborne, solventbased or 2-pack Polyurethanes, Phenolic resins or phenolplasts and their mixtures.

44. A method for the decoration of a porous ceramic substrate, which comprises:
A) applying a hardenable coloring composition comprising a colorant material and a hardenable resin on at least a portion of a ceramic substrate having surface microporosities, such that said hardenable coloring composition penetrates the pores of said ceramic substrate;
B) polymerizing or drying said hardenable coloring composition to firmly fix the colorant material to the decorated ceramic substrate.

45. The method according to claim 43, wherein the hardenable coloring composition is a photocurable resin.

46. The method according to claim 43, wherein the hardenable composition is selected from the group consisting of waterborne and solvent based Alkyd resin (e.g. Synolac, Gelkyd, Unithane, Synaqua—CRAY VALLEY; Uralac, Urathix, Uradil—DSM; Alkydal—BAYER; Laropal—BASF; Vialkyd, Daotan, Resydrols—VIANOVA), waterborne and solventbased Acrylics (e.g. GLASCOL—Ciba Specialty Chemicals; waterborne, solventbased or 2-pack Epoxies, waterborne and solventbased Saturated polyesters, waterborne, solventbased or 2-pack Polyurethanes, Phenolic resins or phenolplasts and their mixtures.
